(19) United States
(12) Patent Application Publication
(10) Pub. No.: US 2015/0127568 A1
(43) Pub. Date: May 7, 2015

(54) INTERACTIVE SYSTEM FOR JOB OFFERING AND SUBSCRIPTION

(71) Applicant: TRENKWALDER S.R.L., Modena (IT)

(72) Inventor: Peter Zehentleitner, Modena (IT)

(73) Assignee: TRENKWALDER S.R.L., Modena (IT)

(21) Appl. No.: 14/366,235

(22) PCT Filed: Dec. 14, 2012
(86) PCT No.: PCT/IB2012/057321

§ 371 Date: Jun. 17, 2014

(30) Foreign Application Priority Data
Dec. 16, 2011 (IB) PCT/IB2011/055754

(51) Int. Cl. G06Q 10/10

(52) U.S. Cl. CPC G06Q 10/1053
USPC 705/321

(57) ABSTRACT

The present invention concerns an interactive system (10) for job offer and subscription exploiting the intermediation of a brokerage firm. The system comprises at least one server (12), one or more first electronic terminals (31a, 31b . . . 31n) located at branch offices of the brokerage firm and connected to the server (12) through a geographical network (14) in order to maintain and update databases (21, 22) containing information about candidate workers, available to perform determined working activities, and companies intending to offer a job to said candidate workers through said brokerage firm. The system is configured so that the candidate workers and the companies are handed over respective electronic cards (25) having a unique identifier and arranged to allow the candidate workers and the companies to remotely subscribe the employment contracts through the connection to the server (12) by means of respective second and third electronic terminals (41a, 41b . . . 41n; 51a, 51b . . . 51n). The invention also concerns a method of job subscription through a brokerage firm.

### TECHNICAL FIELD

The present invention generally relates to a system structured so as to allow interaction between job offer and subscription.

More in detail, the present invention relates to a system structured so as to allow matching the job offer by companies who are clients of brokerage firms with the subscription of the same job by workers included in suitable lists available, for instance, at branch offices of the brokerage firm, distributed in a region-wide and/or nationwide geographical area.

### PRIOR ART

The brokerage firms that, in the presence of job offers from companies who are their clients, place workforce at disposal of the same companies are well known.

Workforce is generally included in suitable lists created and maintained by the brokerage firms, which, depending on the various job offers, propose the workforce to the client companies and also manage contractual aspects, such as the direct engagement of and the wage payment to the workers, consequently to a temporary utilisation of the workers' services by the client companies.

The brokerage firms generally have branch offices that are located in given geographical areas and that provide for collecting information about candidate workers seeking for a job, for screening the workers, for calling them when receiving job offers from the competence area, in order to propose the workers to the client companies, and, upon acceptance by the client company and the candidate, for activating a commercial contract with the client company and an employment contract with the candidate worker.

According to the present state of the art, in the presence of a job offer from a company, the branch office of the brokerage firm, located in a given geographical area, contacts one or more candidates by phone, by selecting them from a list.

Once the available workers have been selected, in a number corresponding to the number requested by the company, such workers are called to the branch office in order to sign the engagement contract, usually a temporary contract, and are sent to the client company that will employ the workers based on the contract signed between the worker and the brokerage firm.

A general problem of the prior art is that the need to contact the available workers and their call to the branch offices often implies long times, for instance at least one working day, often even exceeding the times that would be necessary for complying with the request.

Such a problem is mainly due to at least two reasons.

First, the branch offices often cannot be operating 24 hours a day, seven days a week.

Second, possible job offers which are to be complied with in extremely short time, for instance one or two hours, cannot be met, since the times required to contact the available workers, to call them in order to sign the contract, which operation is often necessary for legal reasons, and to send them to the companies exceed the requested times.

In order to exemplify in more detail the general problem discussed above by referring to specific problems, let us consider the case of a catering company receiving, for instance in the morning, a communication from a member of its staff who informs that he/she is ill and cannot be present at work for one or more days.

Since a catering company is concerned (but what is being described applies also to companies of other kinds), the replacement of the worker must be practically immediate, since preparation of food to be delivered generally precedes by a few hours the effective consumption by clients of the catering company.

According to the prior art, the procedure subsequent to a request for substitution of the worker, of course in the case of intervention of a brokerage firm that usually is organised so as to provide skilled staff in reasonable times, includes the following steps:

the company requests a worker to the brokerage firm (estimated time a few minutes);

an available worker is called to a branch office of the firm as a result of contacts, for instance by phone, with several available workers (estimated time from a few hours to at least one working day, due to the time required for preparing the contract documents);

a contract is signed by the available worker at the branch office (estimated time from a few minutes to at least one hour);

subsequently to the signature, the worker presents himself/herself in the company and starts working as a substitute of the unavailable worker (time corresponding to the time required for the worker to present himself/herself in the company).

The above described example clearly shows that the times for checking the availability of possible substitute workers, the times for signing the contract, the travel times for reaching the branch office and for reaching the company from the branch office, the availability times in terms of working hours of the branch office which, evidently, should be 24 hours a day, including Sundays and holidays, are such that at least one working day is required to have the worker available in the company.

In synthesis, the specific problems related to the most general problem cannot be solved by a change from manual means to information technology means, but they demand an actual new design of the architecture for managing the interaction between job offer by the companies and job subscription by the available staff or candidate workers.

In short, generally, the need exists for the brokerage firms to make the interaction between job offer and subscription or acceptance available at any instant and in timely manner, also in emergency situations, when the job offer by the companies has a practically immediate deadline.

As discussed above, the Applicant has realised that the prior art cannot effectively solve the problems mentioned above, which can be synthesised as the ability of making the brokerage service available at any time, in any situation and in timely manner, while at the same time complying with requirements implicit in the activity of the brokerage firms, such as response time reliability, quality of the selected workers, capability of correctly paying the selected workers, compliance with the regulations, and so on.

### DESCRIPTION OF THE INVENTION

It is an object of the present invention to provide a system structured so as to solve the problems mentioned above of the prior art.

This object is achieved by the interactive system for job offer and subscription as claimed herein.

The present invention also concerns a method of managing job offer and subscription by means of a brokerage firm, as well as a computer program product that can be loaded into the memory of at least one computer and comprises software code portions for carrying out the above method, when the product is run on at least one computer. As used herein, the reference to such a computer program product is meant as being equivalent to the reference to a computer-readable medium containing instructions for controlling a computer system or device in order to coordinate the execution of the method according to the invention.

The reference to “at least one computer” is directed to highlight the possibility that the present invention is performed in distributed manner on a plurality of computers.

The claims are integral part of the technical teaching provided herein in respect of the invention.

According to a feature of a preferred embodiment, the invention provides, in general, that the candidate workers and the companies wishing to avail themselves of the intermediation of a brokerage firm are given suitable electronic cards arranged to allow the candidate workers and the companies to remotely sign or subscribe working contracts in secure and immediate manner through the connection to a server by means of electronic terminals available to the candidates and the companies, respectively.

In particular, according to one of the features of the present invention, it is provided that the contract management architecture includes the preliminary preparation, at the branch offices, of virtual employment contracts with the relevant employment conditions, so that, at the moment of the request for a worker by a company, the formalisation of the real contract may take place by means of a single command, for instance a click on a telephone or a computer terminal.

The new architecture ensures not only security in drawing up employment contracts, but also:

a drastic reduction in the time elapsing between the job request and the job provision, so that times of a few minutes between the request and the provision can be attained;

a drastic reduction in the working hours of the branch offices, since the matching between job request and offer can be obtained by using wholly automatic tools thanks to the new system architecture provided in accordance with the present invention.

According to a further feature of the present invention, the brokerage firm has at disposal a certification device connected to the server and arranged to associate digital certificates with documents signed in advance by the candidates and the companies.

Such a feature enables the companies and the candidate workers to sign multiple employment contracts spaced in time, without the need to go to the branch offices in order to sign every time the contracts, since the availability of a virtual contract signed in advance ensures, thanks to suitable verification and check procedures, the consistency between real and virtual contracts.

### BRIEF DESCRIPTION OF THE FIGURES

The above and other features and advantages of the present invention will become apparent from the following description of a preferred embodiment, made by way of non limiting example with reference to the accompanying drawings, in which elements denoted by a same or similar numerical reference correspond to components having the same or similar function and construction and in which:

FIG. 1 is a synthetic diagram showing the system according to the present invention;

FIG. 2 is a flow chart of some steps included in the operation of the system according to the invention; and

FIG. 3 schematically shows an example of steps of activation of a contract between client company and candidate worker, and of the related times, in a system as shown in FIG. 1.

### DESCRIPTION OF A PREFERRED EMBODIMENT

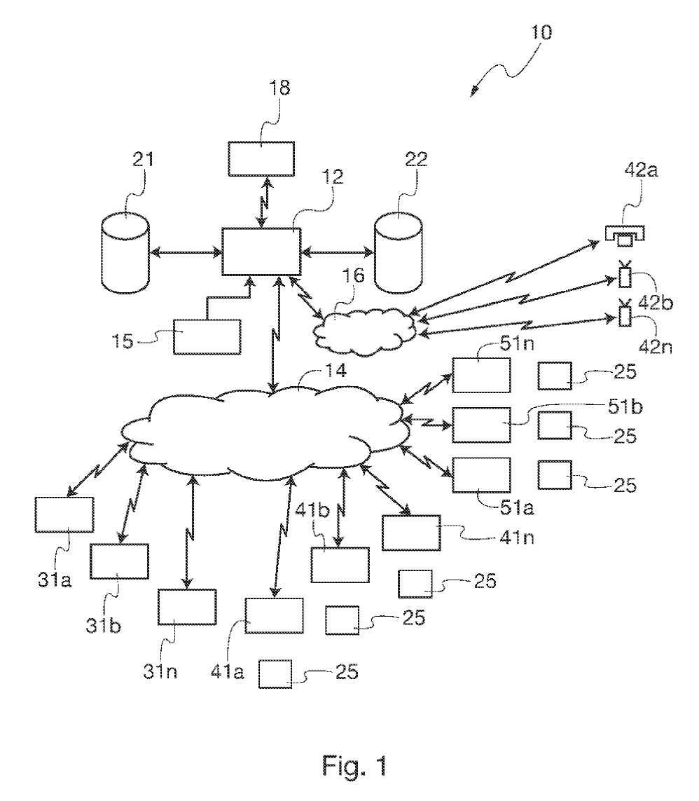

Referring to FIG. 1, an interactive system 10 for employment contract offer and subscription (“system”), in particular for a labour brokerage firm, includes, in the preferred embodiment, a central server (“server”) 12 connected to a geographical network (“network”) 14, for instance an Internet-type network known per se, and arranged to manage transactions through network 14 and to manage and keep up to date at least one first database 21, for instance a database of candidate workers (candidates DB) and at least one second database 22, for instance a database of client companies (clients DB).

Server 12 is for instance a server of known type. The databases, of known type, are relational databases and are preferably located at the brokerage firm's premises.

In the preferred embodiment, server 12 is also connected with a device 15 arranged to generate digital certificates.

Such a device 15, for instance a device commercialised by company GlobalSign, is arranged to allow certifying and time stamping documents signed by both the candidates and the clients, as it will be disclosed in detail later on.

Server 12 is accessed by respective branch offices of the brokerage firm, preferably through network 14, by means of first electronic terminals 31a, 31b . . . 31n, for instance PCs of known type,.

Terminals 31a, 31b . . . 31n are configured so as to exchange information with server 12 and to store, in a manner certified by means of device 15, the documents signed by the candidates and the clients into candidates DB 21 and clients DB 22, respectively.

The certification by means of a device 15 arranged to issue and time stamp digital certificates, for instance certificates recognised also by external bodies, ensures, as known, that the documents associated with the certificates are integral and have not been modified.

As it will be described in detail below, the integrity warranty allows using the certified documents or virtual contracts for activating several job offers and several job subscriptions, respectively, which, if successful, allow signing every time new employment contracts or new subscriptions (real contracts) without turning to the branch offices.

The different contracts will use the original virtual contract as a model, by changing for instance, every time, the only issue date or other specific information items. The individual real contract will then be specifically protected by a digital certificate.

Server 12 is accessed by means of second terminals 41a, 41b . . . 41n, for instance PCs, smart phones or tablets of known type, by the candidates who have been previously certified by the branch offices, preferably through network 14.

The candidates may also access server 12 through further second terminals, such as for instance telephones 42a, 42b . . . 42n, for instance cellular phones or fixed phones, connected to a telephone network 16.

According to such an embodiment, server 12 is connected to both the Internet network 14 and the telephone network 16 by means of respective devices of known type.

Moreover, server 12 is accessed, by means of third terminals 51a, 51b . . . 51n, for instance PCs of known type, preferably through network 14, by the client companies that have been previously certified by the branch offices.

Of course, in accordance with other embodiments, certification might be performed also at the brokerage firm itself.

In accordance with the preferred embodiment, each candidate and one or more representatives of the client companies, in general the users of the system, are handed over an electronic card 25, for instance an OATH (Open AuTHentication) card, each card having an own identifier.

Card (security card) 25 for identification of the user (client or candidate) is, more preferably, a device issued by a third party body, for instance company IRETH, and is arranged to generate temporary passwords valid for a limited time period, for instance 30 seconds.

Transmission, in use, of the temporary password together with the identifier of card 25 to a server 18 of the third party body connected to server 12 of the brokerage firm, allows the third party body to certify the authenticity of the card and, consequently, of the user owning the card.

Preferably, card 25 is handed over to the user (a representative of a client or a candidate) during the certification phase, and the user will use it, together with his/her credentials, including for instance login and password, in order to access server 12.

More particularly, according to the preferred embodiment, the user (client or candidate) may have access through his/her credentials to a personal area reserved to him/her, in which the user can verify the information stored therein and also modify some information items.

For instance the user who is a client can modify, by accessing through his/her credentials (ID and password):

access password;

communication settings;

job offers;

worker's attendance records

and so on.

The user who is a candidate can for instance modify, by accessing through his/her credentials (ID and password):

availability times;

availability dates;

curriculum vitae;

access password;

and so on.

The access through credentials thus allows each user to manage his/her personal area.

Card 25 allows the user to authenticate himself/herself in secure manner (strong authentication) and to perform any operation for matching a client and a candidate, such as for instance offering an employment contract or signing an employment contract, as it will be described later on with reference to the system operation.

As it can be readily understood, security card 25 is handed over only to a physical person the card is associated with, and the person receiving it signs an obligation to guard it and not to give it to other people, whereby he/she takes upon himself/herself the responsibility for the improper use by third parties.

Security card 25 is an important element in the architecture of the system according to the invention, since it allows guaranteeing the authenticity of the user requesting a job or accepting a job request without any risk of malicious intrusion, interference, improper time management of the requests and the request acceptances.

By summarising, system 10 as described has an architecture that allows authenticating the users and exploiting the authentication carried out for a plurality of operations corresponding to job offers, employment contracts or signature of employment contracts.

More particularly, the system architecture according to the invention is substantially different from the prior art architecture, according to which, for each job request by a client, the candidate is to go to the branch office in order to sign the corresponding employment contract.

The architectural decision provided for by the present invention, according to which a virtual contract is prepared before any contractual activity and is to be made effective every time depending on the circumstances, without the need for the user (company and/or candidate) to go to the branch office, allows substantially reducing the time required for matching clients and candidates.

The architectural decision according to which both the clients and the candidates are provided with credentials and security card is not a mere transposition from manual modalities to information technology modalities, but, on the contrary, it represents the provision of tools arranged to allow drawing up temporary contracts distributed in time, which are substantially directly managed by the client and the candidate through an information technology server capable of ensuring a high security standard in matching the transactions, by avoiding the risk of malicious intrusions and improper time management of the requests or the request acceptances.

The operation of system 10 described above is as follows.

In general, the invention provides that the whole of the operations concerning the job offers and the subscriptions of employment contracts related to the offers are carried out in real time by each concerned party thanks to the use of access credentials, of security cards 25 and of the architecture of system 10, described above.

Actually, the architecture of system 10 is such that it allows concentrating many of the operations preparatory to drawing up the actual employment contracts in a preliminary step of candidate and client certification, i.e. already during the step of candidature by each candidate worker and preparation of the possible job offers by client companies.

In other words, the described architecture allows the clients and the candidates to prepare, in a preliminary step, certified documents or virtual contracts that are utilisable every time for drawing up real contracts, generally temporary contracts, distributed in time.

This architectural approach allows drawing up real employment contracts (performing transactions) by using the previously certified reference documents (that is, the previously signed and certified virtual employment contracts) and by checking every time the credentials of the client offering the job and of the candidate accepting it.

### Client Company

In particular, as far as the client companies are concerned, in a first step the client company signs certified documents representing an agreement or virtual contract containing general conditions of operation or activation of real contracts and providing for the handover, by the brokerage firm, first of the credentials for the access to server 12 and subsequently of card 25.

In accordance with the preferred embodiment, the client may access, through its credentials (ID and password) to its personal area.

After having got the access, the client may use the electronic signature by means of security card 25 for subscribing the employment contracts.

This operation can be performed not only be means of fixed terminals, but also by using mobile devices such as smart phones and tablets.

Such a first step, including the client's certification, comprises for instance preparing virtual contractual terms by filling in forms such as:

economic and payment conditions which will be applied to the job offers or labour hire;

general hire conditions;

reasons for resorting to the hire;

synthesis of the conditions which will be applied to the workers;

period of validity of the agreement;

maximum number of workers who can be hired;

specification, in a special annex, of risks related to the job, which risks are then communicated to the workers at the subscription of the employment or service contract, as provided for by the law.

For instance, the general conditions may provide for:

the hire of one or more workers for a given time period, or

a frame hire contract providing for hiring up to a maximum number of workers within a period agreed upon by the client and the brokerage firm when drawing up the frame hire contract, for instance in order to meet requirements related to the periodic fluctuations in the client's production amounts;

the hire of a given worker who is hired for a whole predetermined month in order to face a particular job order, for instance set forth in the contract terms.

Handover of security card 25 to the client allows the client to be able to convert every time the virtual contract into real contracts and, therefore, allows the client to:

activate job requests;

confirm the worker's attendance;

confirm possible extensions;

prepare attendance records;

prepare risk forms;

generally, prepare any kind of document related to the hire;

and so on.

Thanks to the described architecture, the client has the possibility to sign only once, in the certification step, certified documents or virtual contracts with the brokerage firm and to convert every time the virtual contracts into real contracts, without the need to prepare and sign further documents at the client company's premises or, even worse, at the brokerage firm's branch offices at each job request.

Actually, the access through credentials and security card guarantees that the certified documents or virtual contracts filed in the certification step can be converted every time into valid real contracts depending on the client's needs.

The methodology described above allows drastically reducing the matching times between job offer and acceptance of the same job, since it allows activating a substantially direct exchange between client and candidate, thereby avoiding the merely bureaucratic intermediation action of the branch offices in the step of drawing up real contracts.

### Candidate Worker

As far as the candidate worker is concerned, in a first candidature step at a branch office, the candidate for instance sends in his/her curriculum vitae (CV) and has a screening interview.

If the screening is passed, the candidate will be certified, and documents compulsory for the engagement will be collected and countersigned by the candidate, obligations to inform the candidate of the risks related to the job in general are fulfilled, and the candidate is handed over the credentials for access to server 12 (personal ID and password) and card 25 by the brokerage firm.

Also in this case, the signature of the documents compulsory for the engagement represents the preparation of certified documents or virtual contracts arranged to allow the candidates to receive or accept every time job offers.

The personal ID, the password and the handover of card 25 allow the candidate, through programmes developed during the design of system 10 and suitable display and fill-in masks, to authenticate himself/herself on the server and to:

consult his/her personal documents in candidates DB 21;

receive job offers directly on line;

manage his/her working availability by drawing up, for instance, a diary where availability and unavailability dates and times are reported;

exchange communications with the branch office by using information technology means;

remotely follow training courses, for instance about industrial safety, should the worker deem it suitable to deepen the information already obtained on the matter through the documents received during the certification step.

### Client Company and Candidate Worker

By assuming the existence of both clients and candidates who have been certified, that is, who have signed respective certified documents or virtual contracts and therefore own security cards or electronic cards 25, the overall interactive process comprises a first step 100 in which the client company sends a concrete job offer or, if the employment relationship is already active, a job extension offer.

The request is made by means of a connection to server 12 by using a personal ID and a password. Upon setting up the connection, a mask suitably prepared according to programmes developed during the design of system 10 and requesting input of an authentication code generated by means of card 25 is for instance displayed on the PC.

The code, if recognised by server 18 of the third party body (step 110, output Y) allows actually activating the request.

In the negative (step 110, output N), the request is not activated and a limited number of attempts will be permitted; a negative outcome of such attempts will result, for instance, in the release of the connection to server 12.

In case of positive outcome (step 110, output Y), the process continues with a further verification step 120 in which there is checked, based on the information inputted by the client into the mask, whether the request is a nominative request (step 120, output Y) or a generic request (step 120, output N).

In case of a nominative request (step 120, output Y), unless the candidate's diary reveals that the candidate is not available, the request is submitted to the worker, for instance via e-mail or in another manner, on his/her tablet or smart phone, or even via an SMS, through telephone network 16 accessible for instance to server 12 (step 125).

In accordance with the preferred embodiment, the communication to the worker, which is immediate, contains the job offer and, for instance, all relevant information provided for by the client's contract and/or by laws in force, whereby the worker is allowed to fully consider whether the offer is of interest for him/her or not.

In accordance with the preferred embodiment, the request also contains a reply code (Communication Code or CC), for instance a numerical code.

The communication code (CC) is particularly useful in case the contract activation is performed through the call centre of the brokerage firm, by using telephone network 16.

In the latter case, in fact, the candidate possessing a fixed or cellular phone is allotted the possibility of remotely signing the contracts through the call centre, by sending both the authentication code generated by means of security card 25 and the CC to the call centre.

Also in this case, the procedure for signing the real contracts eliminates the need for the candidate to be called at a branch office in order to sign the contract, since certified documents or virtual contracts signed by both the client and the candidate, which can be specialised every time depending on the needs, are available at the brokerage firm.

The worker can accept (step 127, output Y) and declare his/her availability for the received offer (step 130) by accessing server 12 through his/her personal ID and the password and by inputting, into a mask suitably prepared according to programmes developed during the design of system 10, an authentication code generated by means of card 25, as well as the reply code received from server 12.

This operation completes the subscription of the employment contract (step 140), which is immediately made available to the worker, for instance via e-mail and/or in the worker's personal access area, through authentication by means of ID and password.

At the same time, a notice confirming that the worker has accepted the offer and signed the real contract is sent to the client (step 150), into the client's personal area or, if provided for, also via e-mail and/or even via SMS, through telephone network 16 accessible to server 12. In this manner, the client is ensured that the process has been completed, that the job offer has been dealt with and that the legal documents have been collected.

In any case, when a candidate accepts or refuses the job, a document is notified to the client and is stored into the client's digital records, which are accessible by the client by means of ID and password. The notification can take place via SMS, e-mail, smart phone, web portal and so on.

If the worker does not accept the offer (step 127, output N), the client is served a document (step 155), which is stored in similar manner to what occurs at step 150 and which states that the nominative request cannot be complied with.

The service of the document is such as to allow the client to modify, for instance, the job request.

If, at step 120, the job request is not a nominative one (output N), in accordance with the preferred embodiment server 12 transmits the job offer or request and, for instance, all relevant information provided for by the client's contract and/or by laws in force (step 170), to all candidates which have been previously associated with the client company and whose qualifications, based upon their CVs, correspond to the job offer.

Preferably, the request is transmitted to all candidates whose diary, stored in the candidates DB 21 for each candidate, reveals time availability for the job offer.

Another condition for not transmitting the request could result, for instance, from an express exclusion by the candidate, in his/her data area, of job offers from the requesting company.

All candidates receive the job offer with the modalities already disclosed in connection with step 125.

The candidates willing to accept the job offer may access server 12 (step 180) in similar manner to what disclosed for step 130, by declaring their availability.

In accordance with the preferred embodiment, server 12 checks (step 190), based on the programmes developed during the design of system 10, whether the number of candidates is greater than, equal to or smaller than the number of workers requested by the client.

For instance, the client company may request an offer from, that is offer a job to N candidates for N−X jobs, where X is a number smaller than N, so that the first N−X candidates who positively respond to the offer will obtain the job.

Generally speaking, if the number of candidates is greater than the number of jobs offered, the readiness in replying is for instance rewarded, and a message informing that the offer has expired is sent to the excess candidates who have less readily replied. At the same time, the client is informed (step 210) that the offer has been dealt with, in similar manner to what disclosed at step 150,

If the number of candidates is equal to the number of requested workers, the client is simply informed (step 220) that the offer has been dealt with, in similar manner to what disclosed at step 150.

If the number of candidates is smaller, the client is informed that the request has not been completely dealt with (step 230), in order to allow the client to make, for instance, alternative choices.

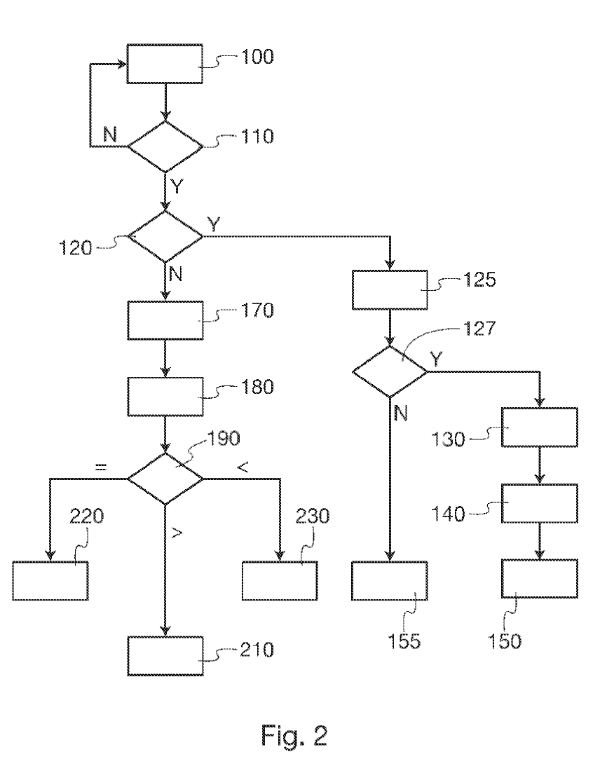

In order to better explain the technical effect attainable with system 10 thanks to its architecture, hereinafter there is reported an exemplary time evolution, detected by the Applicant, between the activation of a job offer (step 100 in the chart of FIG. 2) and the acceptance of or the dealing with the job offer (step 130 or 180 in the chart of FIG. 2).

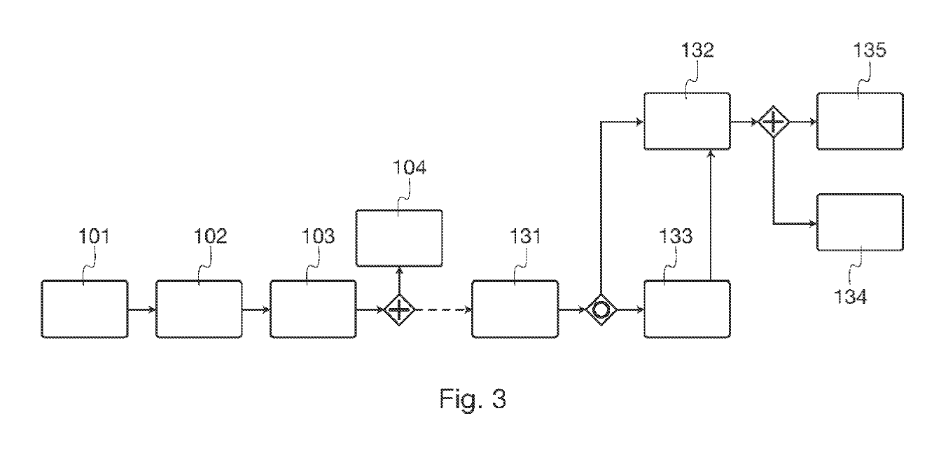

The example is shown in FIG. 3.

The activation of the job offer by the client comprises, in the flow chart shown in FIG. 2, the following steps:

step 101: the client accesses its personal area by inputting its credentials (about 2 minutes);

step 102: the client requests hire of an activity or a service (about 10 minutes);

step 103: the client signs the real contract by using the authentication code provided by security card 25 (about 15 seconds), resulting in the automatic storage (step 104) of the real contract into Data Base 22 at the brokerage firm's premises (about 1 second).

Following the above steps and the check steps already described with reference to the flow chart shown in FIG. 2, the job offer acceptance process comprises the following steps:

step 131: the candidate receives the real contract via e-mail, SMS, smart phone (about 1 second);

step 132: the candidate signs the real contract by using the authentication code provided by security card 25 or by means of a direct communication via the Internet (about 15 seconds) or by calling a toll-free number (step 133) enabled to receive a signature from a remote location (about 5 minutes);

step 134: the client receives the confirmation of the acceptance of the real contract by the candidate, resulting in the automatic storage (step 135) of the real contract into Data Base 21 at the brokerage firm's premises (about 1 second).

The advantages that can be attained thanks to the architecture of system 10 as described are clearly apparent from the description of the operation thereof.

In particular, among the advantages, the following ones can for instance be listed:

expediting the procedures for managing the employment relationship, thanks to the possibility of certifying once and for ever the candidates and the clients, in secure manner, by means of a virtual contract (certified documents);

remotely activating employment contracts without the need for the candidates and/or the companies to be called to the branch offices;

completely eliminating paper in managing the worker's attendance, while maintaining the possibility for the same worker to quickly input his/her attendance data, and for the client to check and confirm said data in simple and immediate manner, wherever the worker or the client is and 24 hours a day;

preferably, thanks to the availability of the data concerning the candidates and the clients, integrating attendance detection processes at the client's premises, so that the data concerning the in/out times, and possibly the interpretation of such data, are immediately available to the worker and the client, without any activity for a manual collection of such data;

making available to the workers, for instance, pay packets, tax return for fiscal purposes, unemployment forms, if provided for.

Such advantages add to the possibility of allowing an interaction between job offers, job candidatures and subscription of the employment contracts, performed substantially in real time and in a substantially secure and protected environment.

Thanks to such advantages, it is possible to obtain subscription of working contracts requiring an urgent activation, one or few hours, and even for very short periods, e.g. of few hours.

In synthesis, the value added over the prior art of the system and the method as described is the possibility of substantially reducing, in the field of the job hire, the impact of bureaucratic burdens of various kinds existing in several countries, since the need for the client and the candidate worker to interact with the branch office of the brokerage firm (also and above all by physically going to the office for subscribing the contracts) when a contract is being drawn up is eliminated.

In order to achieve this object, it is necessary that the client has signed, with the brokerage firm (“firm”), a kind of preliminary contract, referred to herein as “virtual contract”, where the general conditions of use of the service are regulated, which conditions protect the firm from misuse by the client. Actually, the client is offered greater possibilities of activating a candidate worker (selected from a list prepared by the firm) in automatic manner and without the need to interact with an operator at the branch office (the intervention of the branch offices is practically excluded).

The branch offices of the firm will have the only task of monitoring the employment contract and they can finally concentrate their activity on the business of screening and searching the candidates' profiles.

The virtual contract drawn up with the signature of both parties concerns, for instance, a possible specific contract with certain constraints, some possible contract items being listed below:

date of beginning and end;

company's name;

working position;

kind of employment contract applied;

status and salary:

kinds of insurance;

maximum number of workers requested at the same time;

cost derived, for instance, from a commercial estimate;

reason for the hire;

general conditions;

risks for the health and industrial safety;

risk form, for instance attached to the contract.

The above conditions correspond to the conditions the client must conform to, and which are subjected to checks by the system.

Once this virtual contract has been drawn up, the client finds the name of such a contract in a specific section of its personal area or portal, named for instance “activation request”, and it has the possibility of activating one worker or N workers at the same time, by simply starting from a base frame which takes into account the constraints preset in the virtual contract.

The client may supplement this virtual contract with the specifications capable of transforming the virtual contract into a real contract, such as for instance the specifications listed herein, entailing, for instance:

inputting 1 to N candidates;

modifying or inputting the working hours;

inputting a deadline for the validity of the proposal;

modifying the working place;

inputting supplementary information for the candidate(s).

Thanks to the system and the method as described, the work of the branch offices when a real contract is being drawn up is wholly dispensed with, so as to avoid a considerable increase in the time required for selecting the candidates and for drawing up and signing the contracts at the client's and the candidate worker's side.

In the case monitored by the Applicant, such time can be reduced from days down to minutes.

Actually, the contracts are transmitted to the signatories in completely automated manner, for instance by using mail/SMS/the web, and may be signed with advanced electronic signature both via the web, for instance on the company's portal, and through smart phone or tablet, and even by communicating by phone with the company's call centre, which, for instance, can be operating 7 days a week, 24 hours a day. This allows completing the contractual step in a few seconds or minutes, while keeping the legal warranties and the contractual formalities unchanged, since they are predefined in the virtual contract.

In short, thanks to the system and the method as described, all delays due to the temporary unavailability of the signatories, for instance because they are on travel or cannot immediately go to the branch office, are almost wholly abated, and the displacement times, with the only exception of the time necessary for the candidate worker to go from the place where he/she is at the moment of the contract signature to the working place at the utilising client's or company's premises, are reduced to zero. This is carried out while fully observing the formal and substantial obligations provided for by the regulations in force, including the provision of all required documents.

Of course, obvious changes and/or modifications can be made to the above description in respect of the components, circuit elements and connections, as well as in respect of the details of the illustrated construction and the operating manner, without departing from the invention as set forth in the following claims.

1-10. (canceled)

11. An interactive system for job offering and subscription through a brokerage firm, comprising:
at least one server;
one or more first electronic terminals located at branch offices of the brokerage firm and connected to the server, through a geographical network, in order to maintain and update databases containing information about candidate workers, available to perform determined jobs, and about companies intending to offer a job to said candidate workers through said brokerage firm; characterised in that:
said first terminals are configured for preparing virtual employment contracts containing general conditions for the activation of real employment contracts; and in that:
said candidate workers and said companies are handed over, by said branch offices and upon the preparation of the virtual contracts, respective electronic cards having a unique identifier and arranged to allow said candidate workers and said companies to access respective personal areas and to remotely subscribe real employment contracts through the connection to said server by means of respective second and third electronic terminals.

12. The system as claimed in claim 11, wherein said electronic cards are OATH cards and are arranged to generate temporary passwords to be transmitted to said server by means of said second and third electronic terminals.

13. The system as claimed in claim 12, wherein the verification of said temporary passwords is performed by means of a third party server arranged to guarantee the security in the management of the access to the server in a manner independent from said server.

14. The system as claimed in claim 11, further comprising a certification device connected to the server and arranged to associate digital certificates with documents signed by said candidates and said companies, so as to certify and time stamp the documents concerning the remote subscription of the employment contracts.

15. The system as claimed in claim 12, further comprising a certification device connected to the server and arranged to associate digital certificates with documents signed by said candidates and said companies, so as to certify and time stamp the documents concerning the remote subscription of the employment contracts.

16. The system as claimed in claim 13, further comprising a certification device connected to the server and arranged to associate digital certificates with documents signed by said candidates and said companies, so as to certify and time stamp the documents concerning the remote subscription of the employment contracts.

17. A method of interactive remote subscription of employment contracts through a brokerage firm acting as an intermediary between candidate workers, available to perform determined working activities, and companies intending to offer a job to said candidate workers, wherein:
branch offices of the brokerage firm prepare, by means of first terminals connected to a server through a geographical network, agreements or virtual employment contracts containing general conditions for the activation of real employment contracts;
the candidate workers and the companies sign, at the branch offices, the virtual contracts containing general conditions for the activation of real employment contracts (so-called certification);
the companies transmit a real job offer to the server by accessing respective personal areas and by using electronic cards having a unique identifier and codes associated with the cards;
the server:
checks the kind of real job offer in automatic manner; and
transmits the job offer and conditions associated with the job offer to a subset of candidate workers through communication means;
the candidate workers in the subset:
transmit a willingness to subscribe the job offer to the server, by accessing respective personal areas and by using the electronic cards having a unique identifier and codes associated with the cards;
subscribe the real employment contract based on the offer and the conditions associated with the offer.

18. The method as claimed in claim 17, further comprising, simultaneously with the step in which the candidates sign the real contract, the transmission by the server to the company, through the communication means, of a notification concerning the employment contract subscription.

19. The method as claimed in claim 17, wherein the steps in which the companies and the candidate workers use the electronic cards in order to communicate with the server respectively comprise the step of inputting a temporary password generated by the electronic card.

20. The method as claimed in claim 18, wherein the steps in which the companies and the candidate workers use the electronic cards in order to communicate with the server respectively comprise the step of inputting a temporary password generated by the electronic card.

21. The method as claimed in claim 17, wherein the server checks, in automatic manner, whether the candidate workers willing to accept the job fit with the provision of the job offer, thereby conditionally activating the contract subscription.

22. The method as claimed in claim 18, wherein the server checks, in automatic manner, whether the candidate workers willing to accept the job fit with the provision of the job offer, thereby conditionally activating the contract subscription.

23. The method as claimed in claim 17, wherein the companies and the candidate workers are certified through a process of certification or preparation of agreements or virtual employment contracts in which time stamped digital certificates are associated with documents subscribed by said companies and said candidates so as to guarantee the validity of the remote subscription of the employment contracts.

24. A computer program product or set of computer program products loadable in the internal memory of at least one computer and including software code portions arranged to perform, when the product is run on at least one computer, the method according to claim 17.
